(19) United States
(12) Patent Application Publication
(10) Pub. No.: US 2024/0270145 A1
(43) Pub. Date: Aug. 15, 2024

(54) TRAILER WITH LOWERABLE DECK

(71) Applicant: Layne J. Morris, Kanarraville, UT (US)

(72) Inventor: Layne J. Morris, Kanarraville, UT (US)

(21) Appl. No.: 18/435,395

(22) Filed: Feb. 7, 2024

Related U.S. Application Data
(60) Provisional application No. 63/484,849, filed on Feb. 14, 2023.

(51) Int. Cl. B60P 1/28

(52) U.S. Cl. CPC B60P 1/283

(57) ABSTRACT

A trailer includes a deck, a first suspension module coupled to a first wheel, and a second suspension module coupled to a second wheel. Coupled to each suspension module is a lever system. Each lever is actuatable so as to lower and raise the deck to the ground. In some examples, the lever is electrically actuated. In some examples, the deck may further include sloped sides and/or a ramp, allowing for access to individuals of all abilities. In some examples, the deck further includes one or more containment receptacles.

### CROSS-REFERENCE TO RELATED APPLICATIONS

This application claims the benefit of U.S. Provisional Application Ser. No. 63/484,849, filed on Feb. 14, 2023, which is incorporated herein by reference.

### TECHNICAL FIELD

The present disclosure relates to towable trailers. More particularly, the present disclosure relates to a trailer having a lowerable deck.

### BACKGROUND

Transporting objects from one location to another is typically accomplished using a truck bed or trailer. Trailers are convenient for a number of reasons, including larger tow space, lower to the ground access, and the ability to connect or disconnect the trailer as desired. However, despite a trailer's increased ease of access, a user must still load and unload on the trailer's elevated deck. Various ramps exist in the market to aid a user in loading an unloading a trailer. However, depending on the object and the desired use, it may still be difficult to load/unload even with a ramp.

Additionally, there may be times when it is desirable to not unload the object at the destination, such as a portable toilet, but due to the height of the trailer, the user should unload the object for use and then reload when desired. Portable toilets are used at a variety of locations, including work sites (e.g., construction sites) and public gathering sites (e.g., concerts and festivals). These portable toilets are typically transported to the desired location by trailer, where they are unloaded for use. When the use of the portable toilet has ended, it is trailed once more and taken to a new location. The loading and unloading of portable toilets on a trailer is time consuming, difficult, and may be dangerous. As a result, some operators leave their portable toilets mounted on the trailer during use, rather than unloading and then re-loading them. However, leaving the portable toilets on the trailer makes it more difficult for users to access the toilets, as they have to step up onto a trailer. Indeed, for some users, such as those with disabilities, this renders the portable toilet unusable without a ramp or staircase.

The portable toilet industry is governed by a number of agencies that promulgate and enforce various standards and regulations. These agencies include:
ANSI (American National Standards Institute)
OSHA (Occupational Safety and Health Administration)
ADA (Americans with Disabilities Act)
EPA (Environmental Protection Agency)
OWM (Office of Wastewater Management)
DOT (U.S. Department of Transportation)

Accordingly, there is a need for a trailer that can safely and easily transport objects, such as portable toilets, that has a lowerable deck capable of resting on the ground so as to allow ease of access, while maintaining compliance with the relevant regulations. The present disclosure solves these problems and others.

### SUMMARY OF EXAMPLE EMBODIMENTS

In some embodiments, a trailer comprises a deck, a first suspension module coupled to a first wheel, and a second suspension module coupled to a second wheel. The first and second suspension modules are coupled to one another via a shaft. Coupled to at least one suspension module is an actuator. The actuator is coupled between the deck and a shaft, the shaft coupled to a leaf spring being coupled to the wheel. The actuator is actuatable so as to lower and raise the deck. In some embodiments, the actuator is electrically actuated, such as being motor driven. In some embodiments, the deck may further comprise sloped sides and/or a ramp, allowing for access to individuals of all abilities. In some embodiments, the deck further comprises a plurality of securing brackets for securing one or more portable toilets to the deck.

In some embodiments, a method of using a trailer with a lowerable deck comprises securing one or more portable toilets to the deck of the trailer via securing brackets; transporting the portable toilets to the desired location; and, lowering the deck of the trailer to allow ease of access to the portable toilets without the need for removing the portable toilets from the deck. When use is complete, the operator may raise the deck once more (via the actuator) to transport the portable toilets to the next destination.

### BRIEF DESCRIPTION OF THE DRAWINGS

FIG. 1 illustrates a front top perspective view of a trailer with a lowerable deck with the deck raised for transport;

FIG. 2 illustrates a front top perspective view of a trailer with a lowerable deck with the front portion of the deck lowered;

FIG. 3 illustrates a front top perspective view of a trailer with a lowerable deck with the deck completely lowered to the ground;

FIG. 4 illustrates a side elevation view of a trailer with a lowerable deck with the deck raised for transport;

FIG. 5 illustrates a side elevation view of a trailer with a lowerable deck with the front portion of the deck lowered;

FIG. 6 illustrates a side elevation view of a trailer with a lowerable deck with the deck completely lowered to the ground;

FIG. 7 illustrates a front top perspective view of a trailer with a lowerable deck having containment receptacles with the deck completely lowered to the ground;

FIG. 8 illustrates a front top perspective view of a trailer with a lowerable deck with the deck completely lowered to the ground with portable toilets thereon; and

FIG. 9 illustrates a front top perspective view of a trailer with a lowerable deck with the deck completely lowered to the ground.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a trailer that can safely and easily transport objects (e.g., portable toilets), that has a lowerable deck so as to allow ease of access, while maintaining compliance with the relevant regulations. The trailer with lowerable deck disclosed herein solves these problems and others.

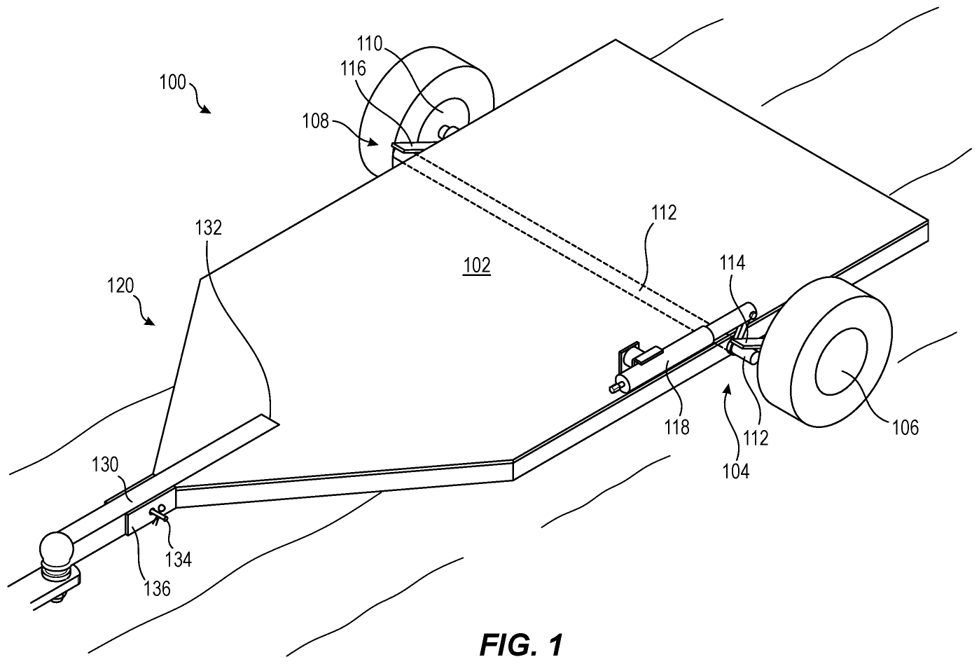

Referring to FIGS. 1-6, in some embodiments, a trailer 100 comprises a deck 102, a first suspension module 104 coupled to a first wheel 106, and a second suspension module 108 coupled to a second wheel 110. The first suspension module 104 is coupled to the second suspension module 108 via a shaft 112. The shaft 112 is coupled to each wheel 106, 110 via a the first and second module 104, 108, which may comprise respective leaf springs 114, 116, resulting in a configuration similar to a torsion beam axle. Because each wheel 106, 110 is coupled to the shaft 112 via a leaf spring 114, 116, respectively, an ideal camber angle is maintained during driving conditions. While the first and second suspension modules 104, 108 are shown as comprising leaf springs 114, 116, it will be appreciated that other mechanisms may be used, such as arms and coil springs.

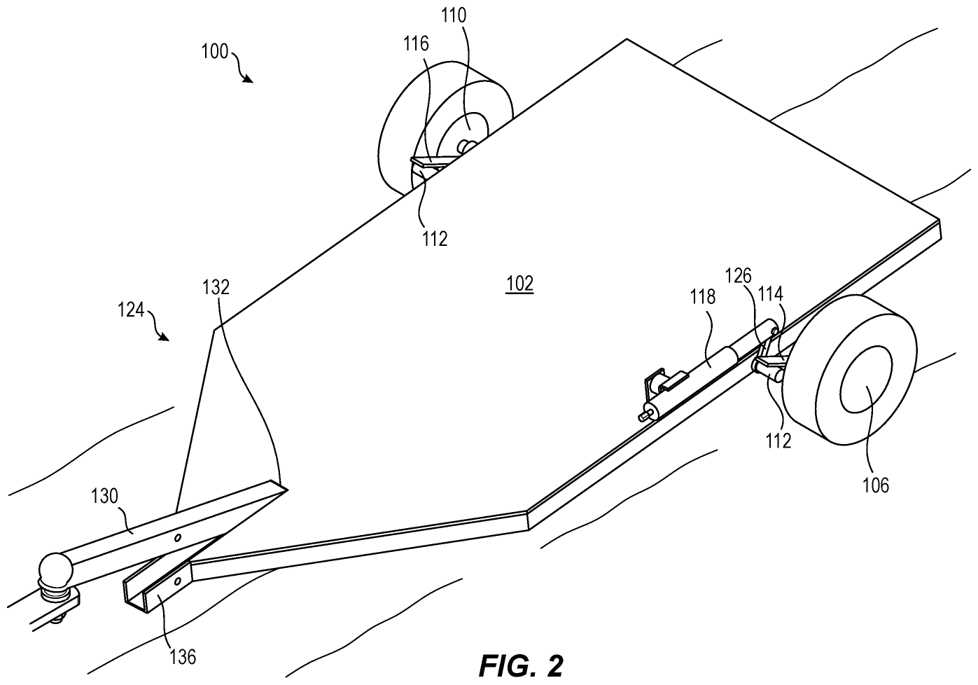

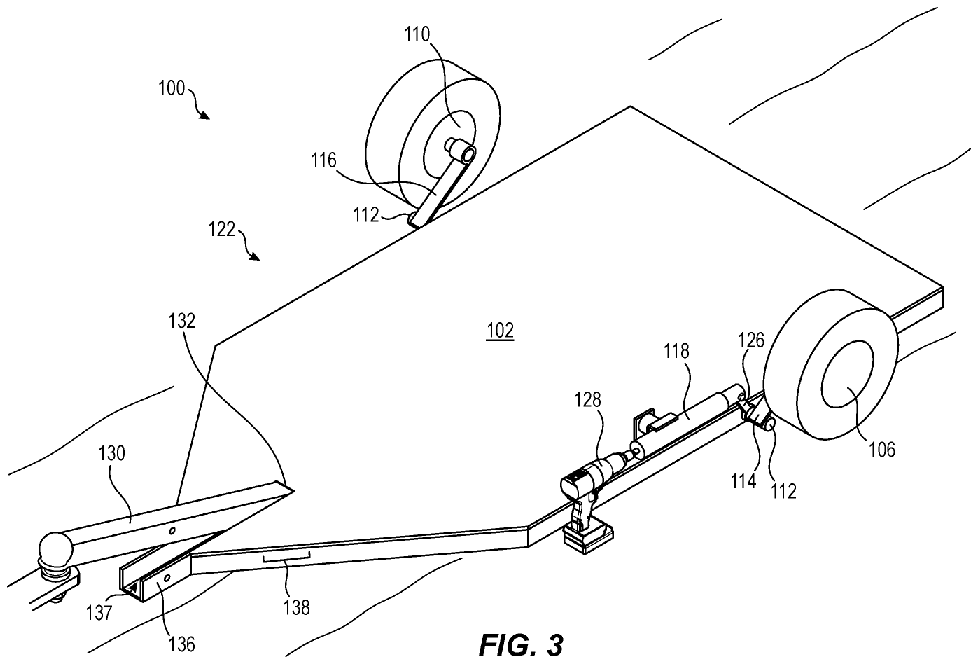

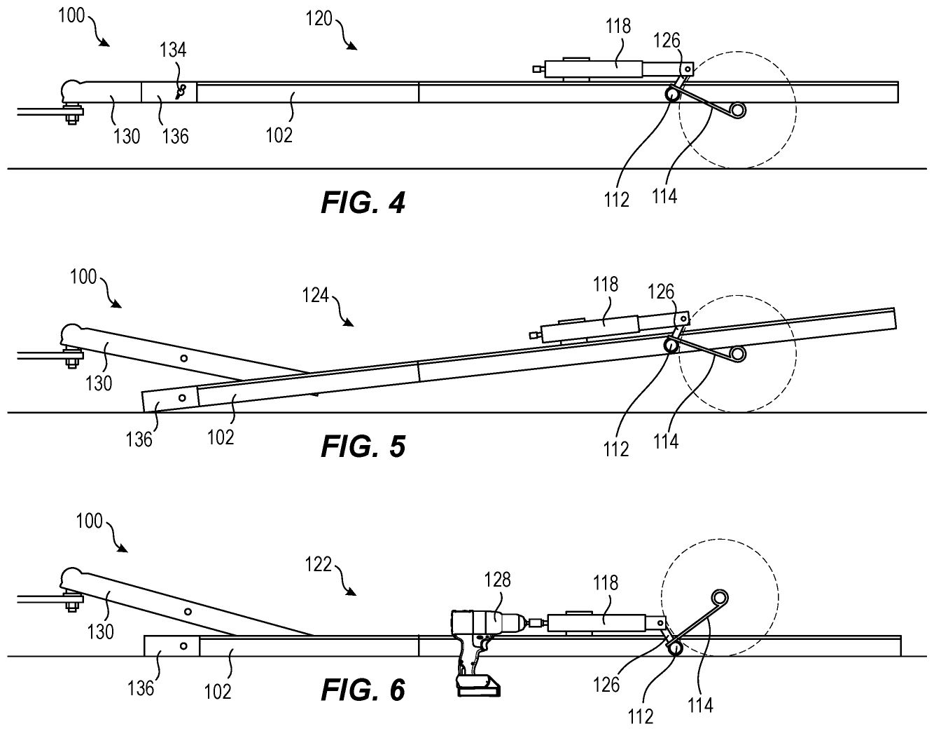

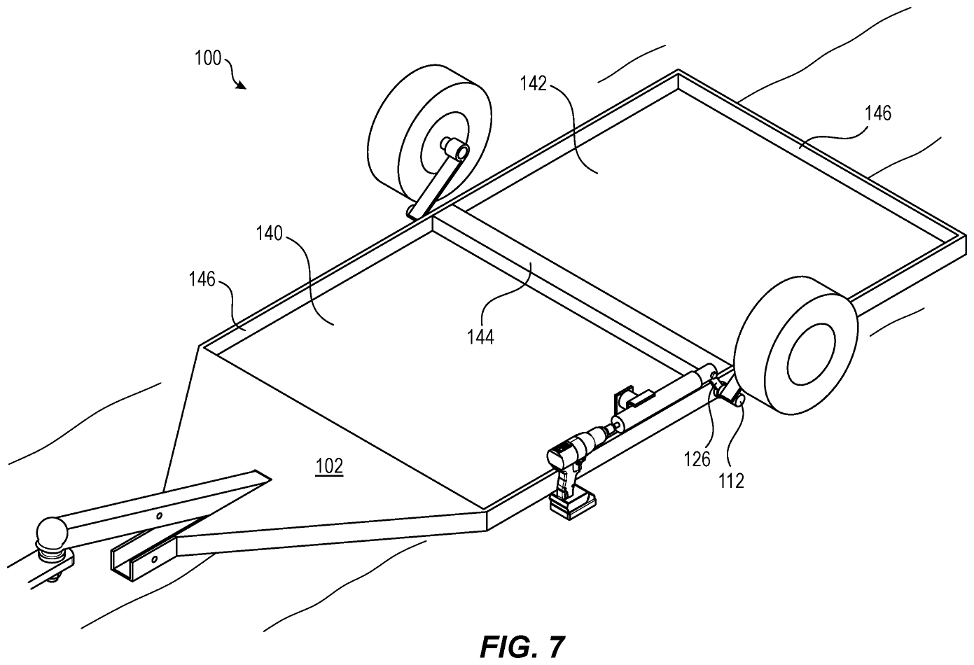

Coupled to at least one suspension module 104 is an actuator 118 (e.g., linear actuator). The actuator 118 is coupled between the deck 102 and the shaft 112 such that actuation of the actuator 118 moves the shaft from a first position to a second position. For example, the trailer 100 comprises a first, raised position 120 as shown in FIGS. 1 and 4, and a second, lowered position 122 as shown in FIGS. 3 and 6. FIGS. 2 and 5 show an intermediate position 124, with the front of the trailer resting on the ground and the rear of the trailer still in a raised position. As shown in FIGS. 1-2 and 4-5, the actuator 118 is in an extended position, wherein a lever 126 coupling the shaft 112 to the actuator 118 is in a first position wherein the shaft 112 is positioned under a portion of the actuator 118, raising the trailer deck 102. As shown in FIGS. 3 and 6, when the actuator 118 is retracted (e.g., piston retracted within cylinder), the lever 126 is likewise actuated, positioning the shaft in a second position away from the actuator 118, thereby lowering the shaft 112, the leaf spring 114 (and leaf spring 116 on the opposite side), and the deck 102.

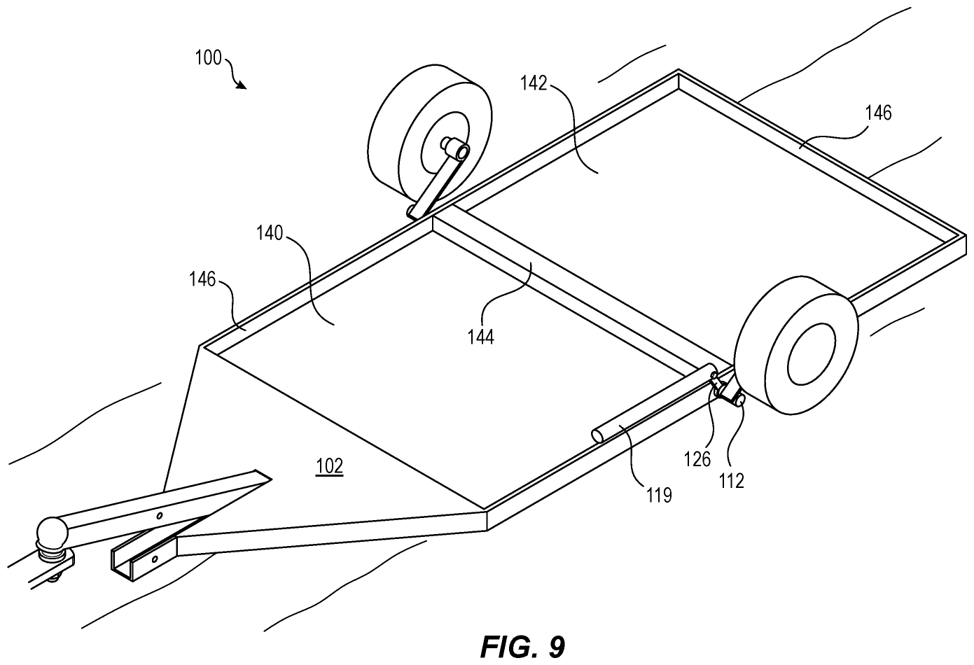

As shown in FIGS. 3 and 6, the actuator 118 may be actuated using a drill 128. However, it will be appreciated that the actuator 118 may be manually driven, such as by hand maneuvering or may be motor driven, such as by using an electric motor 152 (FIG. 8), which may be integral with the actuator 118, or may be removable, such as by using a drill 128 or other mechanism. It will be appreciated that the actuator 118 may be screw-driven or hydraulic so as to have sufficient ability to raise and hold the deck 102 when loaded. It will be appreciated that in some embodiments, the actuator may be a handle lever 119 (FIG. 9), rather than a linear actuator. When using the handle lever 119, which may be actuated by pulling upward on the handle lever 119, additional locking mechanisms, such as locking pins, may be used to ensure the deck 102 remains raised or lowered. In other words, a user may maneuver the handle lever 119 to actuate the lever 126 to thereby raise and lower the deck 102. Once in a desired position, a locking pin, strap, hook, or other locking mechanism may ensure that the handle lever 119 remains in the desired position.

In some embodiments, as shown, the tongue 130 may be hingedly coupled to the deck 102 via hinge 132. This allows the tongue 130 to remain coupled to a vehicle hitch (or trailer stand) while still allowing the deck 102 to be in a raised, first position 120 and in a second, lowered position 122. For example, as shown in FIG. 1, a locking pin 134 (e.g., cotter pin) may be used to secure the tongue 130 to the frame 136 to maintain the first, raised position 120. When it is desirable to lower the deck 102, the locking pin 134 may be removed, allowing the frame 136 to lower from the tongue 130 via the hinge 132 to an intermediate position, as shown in FIGS. 2 and 5. It will be appreciated that the frame 136 may be supported on the end proximal to the ball receiver by a jack or other mechanism that would allow for the frame 136 to be slowly lowered or raised, particularly when there is significant weight on the front end of the deck 102. However, in some embodiments, the frame 136 may be simply lowered to the ground, or lifted therefrom, by hand, such as by a user holding onto a handle 138 (FIG. 3) extending from the frame 136. As shown, the frame 136 may comprise a channel 137 (FIG. 3) complementary in shape to the tongue 130 to thereby prohibit unwanted movement when coupled.

While a linear actuator 118 is shown and described, it will be appreciated that other mechanisms may be used. For example, in some embodiments, rods, racks and pinions, or other mechanisms suitable for raising and lowering the deck may be used. Such mechanisms may be manually actuated, electrically powered, or hydraulically driven. In some embodiments, the trailer 100 may comprise a battery unit configured to provide electricity to motors or pumps (e.g., hydraulic pumps) to actuate the actuator 118.

In some embodiments, the trailer 100 may comprise a control panel or remote for controlling an electrically-powered actuator 118, thereby raising and lowering the deck 102. In some embodiments, the trailer 100 may comprise a transceiver, a microcontroller, and an electric motor 152 (FIG. 8) for actuating the actuator 118. The transceiver may be capable of Bluetooth® or other wireless standards, allowing a user to pair a smartphone or other device and thereby control the motor and actuator 118 via an application on a phone. In some embodiments, the trailer 100 may further comprise one or more sensors (e.g., proximity sensors, pressure sensors, etc.) configured to sense the position of the deck 102 in relation to the ground or other objects.

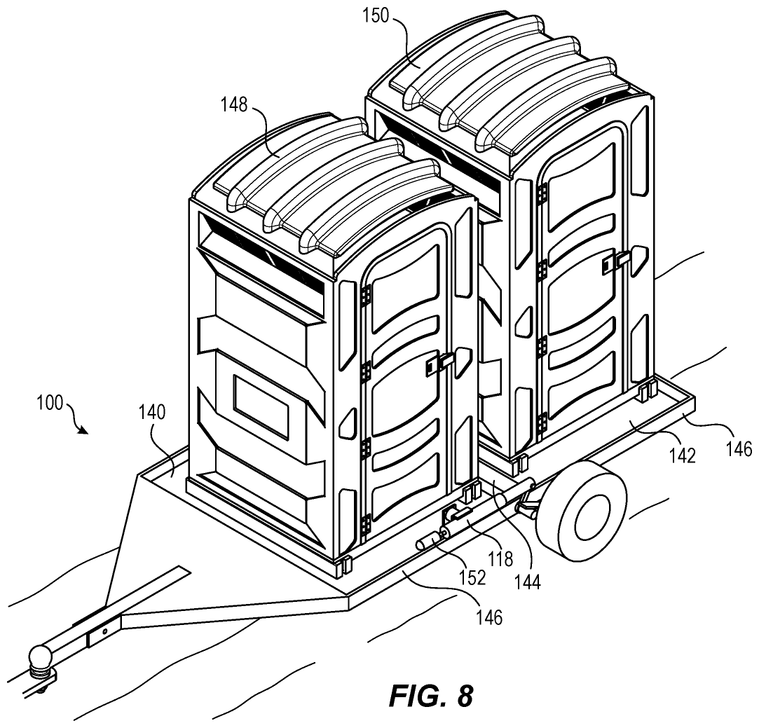

Referring to FIGS. 7-8, in some embodiments, a trailer 100 may comprise a deck 102 comprising one or more containment receptacles 140, 142. The containment receptacles 140, 142 may rest atop a flat deck 102, or as best seen in FIG. 7 may be recessed on the deck 102 with a channel 144 for the shaft 112 therebetween. Each containment receptacle comprises a containment lip 146 around the perimeter to ensure the containment receptacle 140, 142 can contain any liquid spills therein. In other words, each containment receptacle 140, 142 is configured to catch any unwanted spills and to prevent or reduce ground contamination and environmental hazards. The containment lip 146 and/or receptacle 140, 142 may be manufactured from metal, hard plastics, polymers or other impermeable materials configured in orientation and sizing to maximally collect contamination.

For example, as shown in FIG. 8, one or more portable toilets 148, 150 may be situated within a respective containment receptacle 140, 142. The trailer 102 may be lowered to the ground via the motor 152 and actuator 118 so that individuals may conveniently access the portable toilets 148, 150 thereon. In some embodiments, the deck 102 may further comprise sloped sides, stairs, and/or a ramp, allowing for access to individuals of all abilities to the deck 102 of the trailer 100. When a user is ready to move the portable toilets 148, 150, a user raises the deck 102 by actuating the actuator 118 via motor 152 (or drill 128) and raising the frame 136 to the tongue 130. The user may then transport the portable toilets 148, 150 to the desired location. It will be appreciated that while shown with two portable toilets 148, 150 thereon, the trailer deck 102 may be of various sizes, accommodating fewer, or more, portable toilets. Further, while portable toilets 148, 150 have been used as an example herein, the present disclosure is not so limited. In other words, the lowerable deck 102 of trailer 100 may be beneficial for any number of scenarios, including moving furniture, hauling ATVs or lawn mowers, camping equipment, etc. In some embodiments, the trailer 100 may comprise an enclosure (i.e., box trailer).

A method of using a trailer 100 with a lowerable deck 102 comprises, in some embodiments, securing one or more items to be transported to the deck 102 of the trailer 100; transporting the items to the desired location; and, lowering the deck 102 of the trailer 100 to the ground (as shown in FIGS. 3 and 6) via one or more actuators 118 to allow ease of access to the items on the deck 102. When use is complete, the user may raise the deck 102 to a first position (as shown in FIGS. 1 and 4) once more (via the actuator 118) to transport the items to the next destination.

Some benefits of utilizing the trailer 100 with the lowerable deck 102 for portable toilets 148, 150 include increased efficiency for the operator who is transporting and delivering portable toilets—the operator saves enormous time in not having to load and unload portable toilets 148, 150 from the trailer 100. Additionally, because the portable toilets 148, 150 rest on the deck 102, they remain on level, stable ground and remain secured (such as by using brackets on the deck 102, preventing unwanted tipping, while providing equal access to all users.

Accordingly, the trailer with lowerable deck disclosed herein solves the need for a trailer that can safely and easily transport objects/items (e.g., portable toilets, furniture, ATVs, etc.), that has a lowerable deck capable or lowering to the ground so as to allow ease of access, while maintaining compliance with the relevant regulations.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A trailer, comprising:
a tongue;
a deck;
a first suspension module;
a second suspension module;
a shaft coupling the first suspension module to the second suspension module; and
an actuator coupled between the deck and the first suspension module;
wherein actuation of the actuator selectively raises or lowers the deck, wherein in a first position, the deck is raised, and in a second position, the deck rests on the ground.

2. The trailer of claim 1, wherein the first and second suspension modules each comprise a leaf spring coupled to a respective wheel.

3. The trailer of claim 2, further comprising a lever coupled between the shaft and the actuator.

4. The trailer of claim 1, wherein the actuator is driven by a drill.

5. The trailer of claim 1, wherein the actuator is driven by a motor.

6. The trailer of claim 1, wherein the tongue is hingedly coupled to the deck.

7. The trailer of claim 6, wherein the tongue is releasably couplable to a frame.

8. The trailer of claim 1, wherein the deck comprises at least one containment receptacle.

9. A trailer, comprising:
a tongue hingedly coupled to a deck;
a frame comprising a channel configured to receive the tongue;
a locking pin configured to secure the tongue in the channel;
a first leaf spring coupled to a first wheel on a first side of the deck;
a second leaf spring coupled to a second wheel on a second side of the deck;
a shaft extending between the first and second leaf springs;
a first lever coupled to a first end of the shaft on the first side of the deck;
a second lever coupled to a second end of the shaft on the second side of the deck; and
a linear actuator coupled to the first lever and to the deck;
wherein when the linear actuator is in a first, extended position, the deck is in a first, raised position, and when the linear actuator is in a second, retracted position, the deck is in a second, lowered position.

10. The trailer of claim 9, wherein the actuator is driven by a drill.

11. The trailer of claim 9, wherein the actuator is driven by a motor.

12. The trailer of claim 9, wherein the deck comprises at least one containment receptacle.

13. A method of using a trailer with a lowerable deck, comprising:
lowering a deck of a trailer to the ground;
loading the trailer with cargo;
actuating an actuator to raise the deck to a raised position;
towing the trailer with cargo to a desired location; and
actuating the actuator to lower the deck to the ground.

14. The method of claim 13, further comprising securing a tongue of the trailer within a channel of a frame while towing the trailer.

15. The method of claim 13, further comprising allowing a tongue to remain coupled to a hitch of a vehicle when the deck is lowered to the ground by removing a locking pin securing the tongue to a frame, the tongue hingedly coupled to the deck, thereby allowing the deck to rest on the ground while the tongue remains coupled to the hitch.

16. The method of claim 13, wherein the actuator is actuated using a drill.

17. The method of claim 13, wherein the actuator is actuated using a motor.

18. The method of claim 13, wherein the actuator is a handle lever and is actuated by hand maneuvering.
